(19) United States
(12) Patent Application Publication
(10) Pub. No.: US 2025/0351111 A1
(43) Pub. Date: Nov. 13, 2025

(54) METHODS, DEVICES, AND MEDIUM FOR COMMUNICATION

(71) Applicant: NEC CORPORATION, Tokyo (JP)

(72) Inventors: Wei CHEN, Beijing (CN); Gang WANG, Beijing (CN)

(73) Assignee: NEC CORPORATION, Tokyo (JP)

(21) Appl. No.: 18/860,910

(22) PCT Filed: Apr. 29, 2022
(86) PCT No.: PCT/CN2022/090692

§ 371 Date: Oct. 28, 2024

(51) Int. Cl. H04W 64/00; H04L 5/00; H04W 24/08

(52) U.S. Cl. CPC H04W 64/00; H04L 5/0051; H04W 24/08

(57) ABSTRACT

Example embodiments of the present disclosure relate to methods, devices, and medium for communication. If a positioning model is triggered, the communication device obtains a first dataset, where the first dataset is generated based at least on a plurality of reference signals with a first reference signal resource. The communication device trains the positioning model based on the first dataset. The communication device obtains a second dataset based at least on a plurality of reference signals with a second reference signal resource, where a density of the second reference signal resource is sparser than a density of the first reference signal resource. The communication device monitors the trained positioning model based on the second dataset.

### FIELD

Example embodiments of the present disclosure generally relate to the field of communication techniques and in particular, to methods, devices, and computer readable medium for communication.

### BACKGROUND

Several technologies have been proposed to improve communication performances. For example, communication devices may employ an artificial intelligent/machine learning (AI/ML) model to improve communication qualities. The AI/ML model can be applied to different scenarios to achieve better performances.

A recent work item has been conducted in the third generation partner project (3GPP) for positioning support in new radio (NR) system. A new type of reference signals for positioning, positioning reference signals (PRSs), has been introduced in downlink. For example, the terminal devices may measure the reference signal time difference (RSTD) between PRSs from different transmission points in order to perform positioning. Alternatively or in addition, the terminal devices can measure a receiving-transmitting (Rx-Tx) time difference where the time difference is between two PRSs.

### SUMMARY

In general, example embodiments of the present disclosure provide methods, devices and computer storage medium for channel access in millimeter wave bands. Embodiments that do not fall under the scope of the claims, if any, are to be interpreted as examples useful for understanding various embodiments of the disclosure.

In a first aspect, there is provided a method of communication. The method comprises: in accordance with a determination that a positioning model is triggered, obtaining a first dataset, the first dataset being generated based at least on a plurality of reference signals with a first reference signal resource; training the positioning model based on the first dataset; obtaining a second dataset based at least on a plurality of reference signals with a second reference signal resource, the second reference signal resource density being sparser than the first reference signal resource density; and monitoring the trained positioning model based on the second dataset

In a second aspect, there is provided a method implemented at a first device. The method comprises: implemented at a terminal device, comprising: receiving, from a network device, a request to determine a dataset based on multi round trip time (multi-RTT) mechanism; and determining the dataset for a positioning model based on the request, the dataset comprising at least: a characteristic of reference signal time difference (RSTD) with synchronization error, and a characteristic of RSTD without synchronization error or an absolute location of the terminal device.

In a third aspect, there is provided a method implemented at a network device, comprising: transmitting, to a terminal device, a request to determine a first dataset and a second dataset based on multi round trip time (multi-RTT) mechanism, the first dataset being used for training a positioning model and the second dataset being used for monitoring the trained positioning mode; and transmitting, to the terminal device, a first reference signal resource configuration with a first reference signal resource density of the positioning model for a training stage and a second reference signal resource configuration with a second reference signal resource density of the positioning model for a monitoring stage, wherein the second reference signal resource density being sparser than the first reference signal resource density in time domain.

In a fourth aspect, there is provided a communication device. The communication device comprises a processor and a memory. The memory is coupled to the processor and stores instructions thereon. The instructions, when executed by the processor, cause the communication device to perform the method according to the first aspect above.

In a fifth aspect, there is provided a terminal device. The terminal device comprises a processor and a memory. The memory is coupled to the processor and stores instructions thereon. The instructions, when executed by the processor, cause the terminal device to perform the method according to the second aspect above.

In a sixth aspect, there is provided a network device. The network device comprises a processor and a memory. The memory is coupled to the processor and stores instructions thereon. The instructions, when executed by the processor, cause the network device to perform the method according to the third aspect above.

In a seventh aspect, there is provided a computer readable medium having instructions stored thereon, the instructions, when executed on at least one processor, causing the at least one processor to carry out the method according to the first aspect, the second aspect or the third aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication system in which embodiments of the present disclosure can be implemented;

FIG. 2 illustrates a signaling chart illustrating process according to some example embodiments of the present disclosure;

FIG. 3 illustrates an example process of the positioning model according to some embodiments of the present disclosure;

FIG. 4 illustrates a schematic diagram of the first reference signal resource according to some embodiments of the present disclosure;

FIGS. 5A-5B illustrate a schematic diagram of the second reference signal resource 400 according to some embodiments of the present disclosure;

FIG. 6A illustrates an example process for determining an RTT measurement by the network device according to some example embodiments of the present disclosure;

FIG. 6B illustrates a schematic diagram of the scenario for determining the location of the terminal device by considering network devices 120-1 to 120-3 according to some embodiments of the present disclosure;

FIG. 6C illustrates an example scenario according to some embodiments of the present disclosure;

FIG. 7 illustrates a schematic diagram of the positioning model according to some embodiments of the present disclosure;

FIG. 8 illustrates a signaling chart illustrating process according to some example embodiments of the present disclosure;

FIG. 9 illustrates a flowchart of an example method in accordance with some embodiments of the present disclosure;

FIG. 10 illustrates a flowchart of an example method in accordance with some embodiments of the present disclosure;

FIG. 11 illustrates a flowchart of an example method in accordance with some embodiments of the present disclosure; and

FIG. 12 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

Supporting various positioning methods to provide a reliable and accurate location of a terminal device has always been a key feature of 3GPP standard. Further, in 5G-advanced, it has agreed to investigate the potential for AI/ML in air interface to achieve better performances. The traditional positioning methods are difficult to overcome the synchronization error by using reference signals. In this regard, it is worthy applying an AI/ML model into positioning of terminal devices, and the AI/ML based mechanism can be used to improve the positioning accuracy.

For the use case of AI/ML for air interface, positioning methods highly depend on dataset(s) collected from reference signals, thus how to obtain a more accurate dataset may be an issue for improving the positioning accuracy.

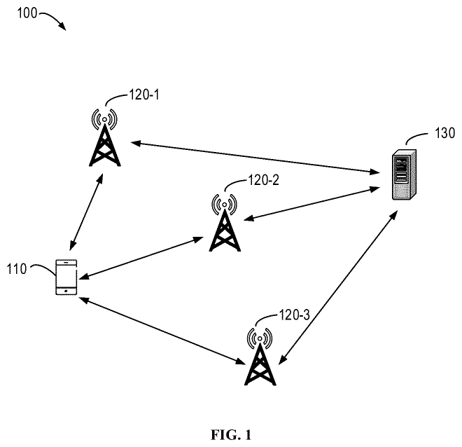

FIG. 1 illustrates an example communication system 100 in which embodiments of the present disclosure can be implemented. The system 100, which is a part of a communication network, includes a terminal device 110. The system 100 further includes a network device 120-1, a network device 120-2 and a network device 120-3, which can be collectively or respectively referred to as “network device 120”. It is noted that only 3 network devices are shown in FIG. 1, but the number of network devices may be more than three, and the network devices 120 in FIG. 1 are given for the purpose of illustration without suggesting any limitations. In some embodiments, the network device 120 may be referred to as an access network device. In some embodiments, the network devices 120-1 to 120-3 may be implemented as multi-transmission and reception point (multi-TRP).

The system 100 further includes a core network device 130, in some embodiments, the core network device 130 may be or may comprise a location and mobility function (LMF). It should be appreciated that the LMF may also be included in an access network device in some scenarios. For ease of description, the core network device 130 comprises the LMF in the following contents in this disclosure. Additionally, the LMF may be referred to a location management function in some embodiments and will not be limited herein.

In the system 100, the network device 120 can communicate/transmit data and control information to the terminal device 110, and the terminal device 110 can also communicate/transmit data and control information to the network device 120. A link from the network device 120 to the terminal device 110 is referred to as a downlink (DL), while a link from the terminal device 110 to the network device 120 is referred to as an uplink (UL). DL may comprise one or more logical channels, including but not limited to a Physical Downlink Control Channel (PDCCH) and a Physical Downlink Shared Channel (PDSCH). UL may comprise one or more logical channels, including but not limited to a Physical Uplink Control Channel (PUCCH) and a Physical Uplink Shared Channel (PUSCH). As used herein, the term “channel” may refer to a carrier or a part of a carrier consisting of a contiguous set of resource blocks (RBs) on which a channel access procedure is performed in shared spectrum.

Communications in the system 100, between the network device 120 and the terminal device 110 for example, may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHZ, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

It is to be understood that the numbers of devices (i.e., the terminal devices 110 and the network device 120) and their connection relationships and types shown in FIG. 1 are only for the purpose of illustration without suggesting any limitation. The system 100 may include any suitable numbers of devices adapted for implementing embodiments of the present disclosure.

The term “slot” used herein refers to a dynamic scheduling unit. One slot comprises a predetermined number of symbols. The term “downlink (DL) sub-slot” may refer to a virtual sub-slot constructed based on uplink (UL) sub-slot. The DL sub-slot may comprise fewer symbols than one DL slot. The slot used herein may refer to a normal slot which comprises a predetermined number of symbols and also refer to a sub-slot which comprises fewer symbols than the predetermined number of symbols.

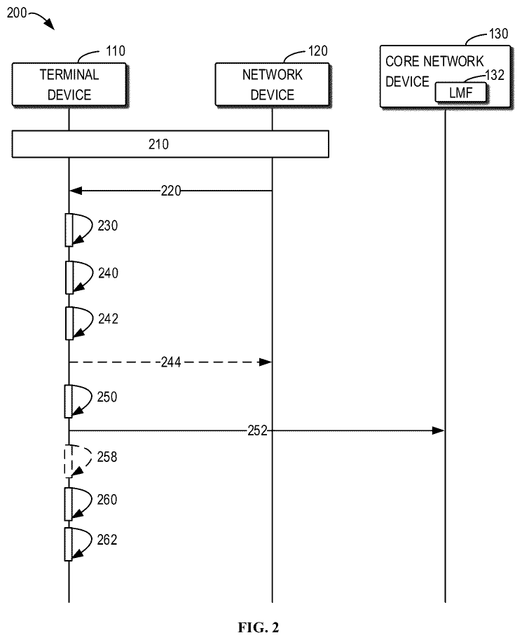

Embodiments of the present disclosure where the AI/ML based positioning model is implemented at the terminal device will be described in detail below. To simplify the description, the AI/ML based positioning model is called as a positioning model for short. Reference is first made to FIG. 2, which illustrates a signaling chart illustrating process 200 according to some example embodiments of the present disclosure. Only for the purpose of discussion, the process 200 will be described with reference to FIG. 1. The process 200 may involve the terminal device 110, the network device 120 and the core network device 130 in FIG. 1, and the core terminal device 130 comprises LMF 132.

The positioning model is triggered 210. In some embodiments of the present disclosure, the triggering operation may be caused by the terminal device 110 or by the network device 120, and the triggering condition(s) may be determined by the terminal device 110 or by the network device 120, based on the specific implementation. Some exemplary examples of the triggering condition are listed as below:
the line of sight (LOS) path does not exist due to a movement of the terminal device 110,
the LOS path does not exist due to changes of propagation environment,
an unexpected synchronization error between the terminal device 110 and the network device 120 or between network devices 120,
the reference position is inaccurate due to the movement of the network device 120, or
a poor DL hearability from the neighbor cell to the terminal device 110.
   It should be noted that the triggering condition may comprise any other conditions which are not described herein.

The network device 120 transmits 220 a configuration message to the terminal device 110. The configuration message may be implemented as a Radio Resource Control (RRC) signaling or may be implemented as an LTE positioning protocol (LPP) layer signaling. For example, the configuration message may be received by the terminal device 110 from the LPP layer. In some embodiments, the configuration message may be used to configure some related parameters for using the positioning model.

In some embodiments, the configuration message may comprise a request to determine datasets based on multi round trip time (multi-RTT) mechanism. In some examples, the network device 120 may configure an IE, such as “NR-Multi-RTT-RequestLocation Information”, as the request to get the terminal device 110 receiving-transmitting (Rx-Tx) time difference, which can be used as an output of the positioning model.

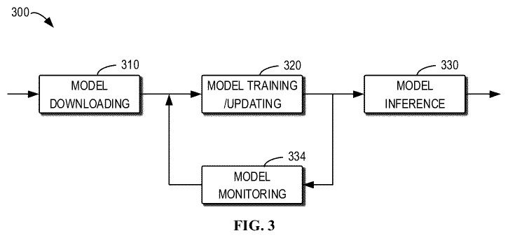

The using of the positioning model may relate to a plurality of stages during the lifecycle, including model training, model inference, model monitoring and model updating. FIG. 3 illustrates an example process 300 of the positioning model according to some embodiments of the present disclosure. As shown in FIG. 3, a positioning model may be downloaded in the stage of model downloading 310, and may be trained in the stage of model training 320. The trained model may be used in the stage of model inference 330. Additionally, a stage of model monitoring 334 is needed to make sure that the error of the model is still acceptable with the change of channel environment, and in some cases, the stage of model updating may be needed based on the monitoring results. It is noted that the stage of model training and the stage of model updating may be with similar operations, however the datasets may be obtained in different ways.

The request transmitted by the network device 120 may indicate that the terminal device 110 should determine a first dataset for a training stage and a second dataset for a monitoring stage based on a multi-RTT mechanism. The multi-RTT mechanism in the present disclosure may involve several network devices, such as network devices 120-1 to 120-3 shown in FIG. 1. It is noted that the training stage may also be called as a stage of model training, a model training stage, a model training phase, etc. Similarly, it is noted that the monitoring stage may also be called as a stage of model monitoring, a model monitoring stage, a model monitoring phase, etc.

In some embodiments, the configuration message may comprises a first configuration and a second configuration, where the first configuration indicates a first reference signal resource for the stage of model training, the second configuration indicates a second reference signal resource for the stage of model monitoring, and the second reference signal resource is sparser than the first reference signal resource. In some embodiments, the periodicity of the first reference signal resource may not exceed a first threshold and the periodicity of the second reference signal resource may exceed a second threshold, where the first threshold may equal to the second threshold or the first threshold may be less than the second threshold.

In some examples, the first configuration of the first reference signal resource is used for obtaining a first set of reference signals for training the positioning model, and the second configuration of the second reference signal resource is used for obtaining a second set of reference signals for monitoring the positioning model. It should be understood that the first configuration and the second configuration may be used to determine a first dataset for training and a second dataset for monitoring, where the first dataset is based on a first set of reference signals and the second dataset is based on a second set of reference signals. The first set of reference signals are much denser than the second set of reference signals, in other words, the second set of reference signals are sparser than the first set of reference signals. In some embodiments, the first reference signal resource can indicate the resource on which the first reference signals transmitted and the first reference signals are used for determining the first dataset. In some embodiments, the second reference signal resource can indicate the resource on which the second reference signals transmitted and the second reference signals are used for determining the second dataset.

In some embodiments, since the second reference signal resource is sparser than the first reference signal resource, the first density of the first set of reference signals is larger than a second density of the second set of reference signals. In some embodiments, the first density may refer to a first number of RSs in a time unit, the second density may refer to a second number of RSs in a time unit, and the first number is greater than the second number. The time unit may be any time length, such as a slot or a sub-frame. In some other embodiments, the first density (e.g., the first number) exceeds a first preset value and the second density (e.g., the second number) does not exceed a second preset value, where the first preset value may equal to the second preset value or the first preset value may be greater than the second preset value.

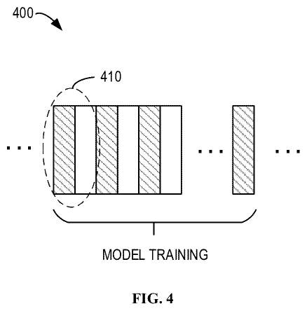

In some embodiments, the first configuration may include a first periodicity of reference signals. The first periodicity may refer to the number of symbols between any two starting symbol of adjacent reference signals. FIG. 4 illustrates a schematic diagram of the first reference signal resource 400 according to some embodiments of the present disclosure. As shown in FIG. 4, the first periodicity 410 may be 2. In some examples, the first periodicity of reference signals may be represented by an IE “PRS−Periodicity”, such as PRS−Periodicity=2. In some other embodiments, the first configuration may include a duration of reference signals indicating the number of free symbols between any two adjacent reference signals. For example, the duration may be 1 for the reference signals in FIG. 4.

In some embodiments, the second configuration may include at least one of: (1) a number of reference signals within a group of reference signals, (2) a second periodicity of reference signals for each group of reference signals, where each group comprises the number of reference signals, or (3) a gap between a first group of reference signals and a second group of reference signals following the first group.

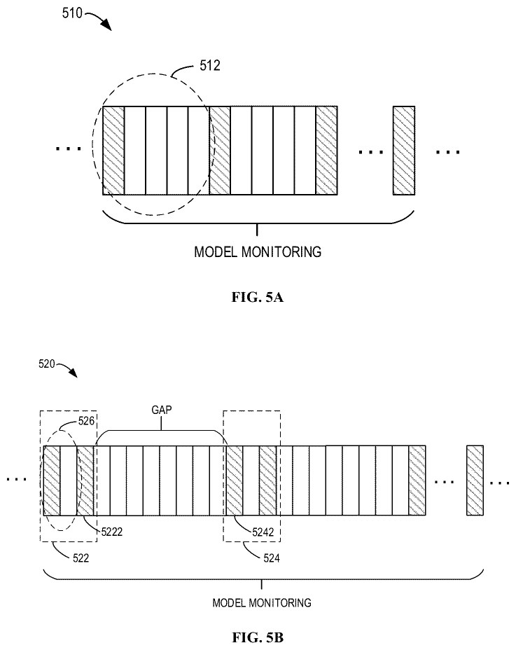

In some examples, the second configuration may include a second periodicity of reference signals for each group of reference signals, which may refer to as a second periodicity of reference signals for short. In this case, any group of reference signals may be regarded as including only one reference signal, in other words, the number of reference signals with in a group is 1. The second periodicity may refer to the number of symbols between any two adjacent reference signals, which is greater than the first periodicity discussed above. FIG. 5A illustrates a schematic diagram of the second reference signal resource 510 according to some embodiments of the present disclosure. As shown in FIG. 5A, the second periodicity 512 may be 5. In some examples, the second periodicity of reference signals may be represented by another IE “PRS−Periodicity”, such as PRS−Periodicity=5.

In some examples, the second configuration may include: (1) a number of reference signals within a group of reference signals, (2) a second periodicity of reference signals for each group of reference signals, and (3) a gap between a first group of reference signals and a second group of reference signals following the first group. For example, the number of reference signals in a group may be represented as an integer N1, which is larger than 1. The second periodicity may refer to the number of symbols between any two starting symbol of adjacent reference signals in a group. The gap between two adjacent groups may refer to the number of free symbols between the last symbol of the reference signal in the first group and the first symbol of the first reference signal in the second group, where the second group is the group immediately following the first group.

FIG. 5B illustrates a schematic diagram of the second reference signal resource 520 according to some embodiments of the present disclosure. As shown in FIG. 5B, the group 522 and the group 524 each have two reference signals, i.e., the number of reference signals in a group is 2. The second periodicity 526 is 2 in FIG. 5B since the number of symbols between two adjacent reference signals in a group is 2. The gap between two groups is 8, since there are 8 symbols between the last reference signal 5222 in group 522 and the first reference signal 5242 in group 524. In some examples, the number of reference signals within a group of reference signals may be represented by an IE “PRS-Duration” or “PRS-times”, such as PRS−Duration=2. The second periodicity of reference signals may be represented by another IE “PRS−Periodicity”, such as PRS−Periodicity=2. The gap between two groups may be represented by an IE “PRS−ResourceInstanceGap”, such as PRS−ResourceInstanceGap=8.

In some embodiments, the first configuration and/or the second configuration may further comprise other information, for example, the first configuration may comprise a first resource repetition factor for the first reference signal resource, and the second configuration may comprise a second resource repetition factor for the second reference signal resource. As an example, the first resource repetition factor equals to 1, and the second resource repetition factor equals to 1 too.

It should be appreciated that the first configuration and the second configuration may be implemented by other means; those skilled in the art would understand that the description in FIG. 4 and FIGS. 5A-5B are given for the purpose of illustration without suggesting any limitations.

In some embodiments, the configuration message may comprise information indicating a time period between the end of model training stage and the start of model monitoring stage. The time period may indicate a time gap between the training stage and the monitoring stage, in this case, the monitoring is not needed right away while the training is completed. In some examples, the configuration message may comprise several periods corresponding to several model stages, and thus the terminal device 110 may determine the time period between the model training stage and the model monitoring stage. In some examples, the configuration message may comprise information indicating the specific time resources for monitoring, and thus the terminal device 110 may determine the time period between the model training stage and the model monitoring stage based thereon.

Additionally or alternatively, in some embodiments, the configuration message may comprise a termination indication for model training. The termination indication for model training may refer to a termination condition, and in case the termination condition meets, the training will be terminated.

In some examples, the termination indication may be a training duration, which can represent the total time length of the training stage. In some examples, the termination indication may be a number of the plurality of reference signals, which can represent the total number of reference signals used in the training stage. For example, the total number of reference signals used in the training stage may be represented as an integer N2, in this event, the first set of reference signals for training the positioning model may comprise N2 reference signals obtained based on the first configuration of the first reference signal resource discussed above.

Based on the configuration message described above, the network device 120 may configure some parameters for using the positioning model. The configuration message may comprise assistance data to enable the terminal device 110 to train and/or monitor the model. In some embodiments, an IE “AI-provide AssistanceData” may be used by the location server (such as the network device 120) to provide assistance data to enable UE-assisted and UE-based positioning. An example of the IE “AI-provide AssistanceData” may be shown in Table 1 below.

TABLE 1
NR-AI-ProvideAssistanceData ::= SEQUENCE {
...

| | |
|---|---|
| nr-AI-Assistance-ModelTraining | NR-AI-Assistance-ModelTraining, |
| nr-AI-Assistance-ModelMonitoring | NR-AI-Assistance-ModelMonitoring, |
| nr-AI-Gap-between-Training-and-Monitoring | ENUMERATED {s1, s2, s4, s8, s16, s32, ...} |

...
}

The IE “nr-AI-Assistance-ModelTraining” shown in Table 1 may indicate the request, the first configuration, and the termination indication as discussed above. The IE “nr-AI-Assistance-ModelMonitoring” shown in Table 1 may indicate the second configuration as discussed above. The IE “nr-AI-Gap-between-Training-and-Monitoring” may indicate the time period as discussed above.

It is to be understood that the above description about the configuration message is for purpose of illustration without any limitation. In some examples, the configuration message may further comprise other information, such as those indicating the parameter(s) used during the stage of model inference 330. For example, the configuration message may comprise a third configuration of a third reference signal resource of the positioning model for the stage of model inference 330. In some embodiments, the first reference signal resource is denser than the third reference signal resource and the second reference signal resource is sparser than the third reference signal resource. In some examples, the configuration message may be transmitted by the network device through one or more signallings. In some examples, different information in the configuration message may be applied separately or in any suitable combination.

Now further referring to FIG. 2, the terminal device 110 determines 230 a first dataset for training the positioning model. Specifically, the first dataset is based on a plurality of reference signals obtained based on the first reference signal resource, where the first reference signal resource has been discussed above.

The first dataset may be generated by the terminal device 110 based on the multi-RTT mechanism. In some embodiments, the plurality of reference signals for the first dataset may comprise positioning reference signals from the network device 120. For example, the terminal device 110 may receive the positioning reference signals from the network device 120 based on the first periodicity. In some embodiments, the plurality of reference signals for the first dataset may comprise sounding reference signals transmitted from the terminal device 110 to the network device 120. For example, the terminal device 110 may transmit the sounding reference signals to the network device 120 based on the first periodicity. The description about the first periodicity has been discussed above, such as by referring to FIG. 4.

In some embodiments, the first dataset may comprise (1) a characteristic of RSTD measurements with synchronization error and (2) a characteristic of RSTD measurements without synchronization error or an absolute location of a terminal device, which can be obtained based on the multi-RTT mechanism. In some examples, the RSTD measurements with synchronization error may be called as measured RSTD from reference signals, which can be obtained by performing measurements on the first set of reference signals. In some examples, the RSTD measurements without synchronization error may be called as transformed RSTD from UE Rx-Tx difference measurements. The multi-RTT mechanism in the present disclosure may involve several network devices, such as network devices 120-1 to 120-3 shown in FIG. 1.

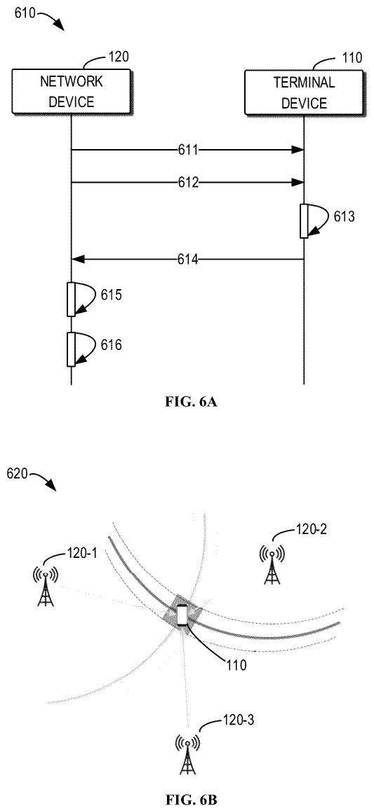

FIG. 6A illustrates an example process 610 for determining an RTT measurement by the network device 120 according to some example embodiments of the present disclosure. The network device 120 transmits 611 an RTT request to the terminal device 110, and accordingly the terminal device 110 receives the RTT request. The network device 120 transmits 612 a downlink reference signal to the terminal device 110, for example, the transmission can be made at to and the transmitted downlink reference signal may be a positioning reference signal. The terminal device 110 may determine 613 time of arrival (TOA) of the positioning reference signal by performing a measurement on the received positioning reference signal, and the TOA determined by the terminal device 110 may be represented as t₁ for example. The terminal device 110 transmits 614 an uplink reference signal to the network device 120, for example, the transmission can be made at t₂ and the transmitted uplink reference signal may be a sounding reference signal. Accordingly, the network device 120 may determine 615 TOA of the sounding reference signal by performing a measurement on the received sounding reference signal, and the TOA determined by the network device 120 may be represented as t₃ for example. And then the network device 120 determines 616 the round trip time (RTT). In some embodiments, the determined RTT can be represented as t₃−t₀−(t₂−t₁). Therefore, the distance between the network device 110 and the terminal device 120 can be determined by considering relative time.

It is noted that, although FIG. 6A shows that the RTT is determined by the network device 120, the RTT can also be determined by the terminal device 110. In other words, the Rx-Tx time difference on the reference signals can be measured on both sides.

In the multi-RTT mechanism, the location of the terminal device 110 can be determined by considering more than two network devices. FIG. 6B illustrates a schematic diagram of the scenario 620 for determining the location of the terminal device 110 by considering network devices 120-1 to 120-3 according to some embodiments of the present disclosure. It is understood that since the relative time is used, there is no need for requiring the network devices 120-1 to 120-3 to transmit reference signals at the same time, therefore, there are low requirements for synchronization among the network devices.

It is understood that for existing synchronization errors between TRPs, the RS are required for both UL and DL, which causes the overhead of RS to be pretty large. In some embodiments of the present disclosure, if the RTT values between the terminal devices 110 and any more than two network devices 120 are known, the RSTD measurements without synchronization error (or called as real RSTD) from these network devices may be transformed. In this regard, the terminal device 110 may determine the characteristic of RSTD measurements without synchronization error and/or the absolute location of the terminal device 110 from the multi-RTT indirectly.

FIG. 6C illustrates an example scenario 630 according to some embodiments of the present disclosure. Specifically, for the case that a synchronization error exists between the network devices 120-1 and 120-2, a first distance between the network device 120-1 and the terminal device 110 may be determined, and a second distance between the network device 120-2 and the terminal device 100 may be determined too, and further the characteristic of RSTD measurements without synchronization error and/or the absolute location of the terminal device 110 can be calculated from the first distances and the second distances.

As such, the first dataset can be determined by the terminal device 110. In some embodiments, the first dataset collection performed by the terminal device 110 can be Rx-Tx time difference based, for scenes with large synchronization error, since the position obtained by the measurement is more accurate and timely.

Further, the terminal device 110 trains 240 the positioning model. In some embodiments, a model may be stored in a specific storage, for example in the network device 120, and the model may be a highly generalized AI/ML model. The terminal device 110 may download the model, from the network device 120 for example, and train the model using the first dataset.

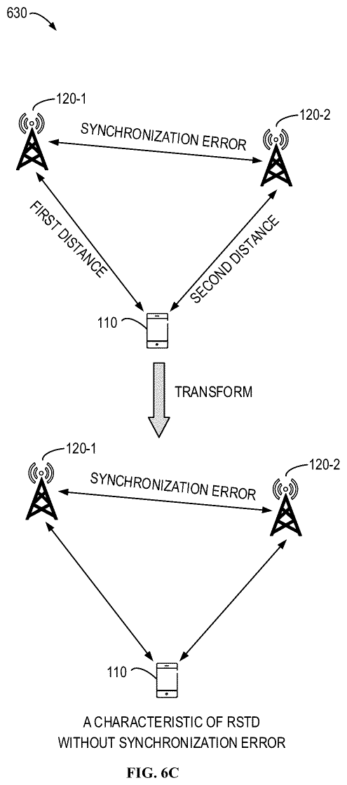

FIG. 7 illustrates a schematic diagram of the positioning model 700 according to some embodiments of the present disclosure. The input of the model 700 may be a characteristic of RSTD measurements with synchronization error 710, and the output of the model may be a characteristic of RSTD measurements without synchronization error 722 or may be an absolute location of the terminal device 724.

Based on the first dataset, the accuracy of the positioning model can be improved and the trained positioning model can be used to infer a location of the terminal device later.

The terminal device 110 terminates 242 the training. In some embodiments, the training may be stopped based on a termination condition. In some embodiments, the terminal condition may be configured by the network device 120, for example, the termination indication included in the configuration message discussed above. The termination indication may be a training duration or may be a number of reference signal resources discussed above. In this event, the terminal device 110 can perform the training within the training duration, and the training is completed as long as the training duration lapses.

In some embodiments, the termination condition may be determined by the terminal device 110. For example, the configuration message does not comprise a termination indication and the terminal device 110 can judge whether the training is completed by itself.

In some examples, if the termination condition is determined by the terminal device 110, alternatively the terminal device 110 may transmit 244 an uplink transmission to the network device 120 to notify that the training has been completed.

Additionally, the terminal device 110 determines 250 location related information of the terminal device 110 based on the trained positioning model. Specifically, the trained positioning model can be used during the stage of model inference.

In some embodiments, the terminal device 110 can get the measurements on the uplink reference signals and the downlink reference signals, according to the service requirements. In the case of existing a synchronization error, the measured value may have some errors compared with the actual value. The trained positioning model can be used to eliminate the errors. Specifically, the synchronization error can be known after the stage of model training, where the training is based on the first dataset. Therefore, the positioning model can get a result which compensates the synchronization error.

The terminal device 110 obtains the output of the positioning model, where the output represents the location related information of the terminal device 110. In some embodiments, the location related information of the terminal device 110 may be RSTD without synchronization error. In some embodiments, the location related information of the terminal device 110 may be an absolute location of the terminal device 110.

The terminal device 110 transmits 252 the location related information of the terminal device 110 to the core network device 130, specifically, to the LMF 132. Therefore, the location of the terminal device 110 can be reported to the LMF 132.

The terminal device 110 determines 260 a second dataset for monitoring the trained positioning model, and the terminal device 110 monitors 262 the trained positioning model based on the second dataset.

Specifically, the second dataset is based on a plurality of reference signals obtained based on the second reference signal resource, where the second reference signal resource has been discussed above, by referring to FIGS. 5A-5B. The second dataset may be generated by the terminal device 110 based on the multi-RTT mechanism. In some embodiments, the second dataset may comprise (1) a characteristic of RSTD measurements with synchronization error and (2) a characteristic of RSTD measurements without synchronization error or an absolute location of a terminal device, which can be obtained based on the multi-RTT mechanism. It is noted that the terminal device 110 can collect the second dataset in a similar way with that for the first dataset discussed above referring to process 230, and will not be repeated for brevity.

Alternatively or in addition, the terminal device 110 may determine 258 whether the time period lapses after the training is terminated. For example, a timer may exist at the terminal device 110 and the timer can be started when the training is completed. If the terminal device 110 determines that the time period lapses, then the terminal device 110 can determine the second dataset and monitor the positioning model. If the terminal device 110 determines that the time period has not lapsed, then the terminal device 110 continues timing without monitoring the model. In some embodiments, information about the time period can be included in the configuration message indicating a gap between the training stage and the monitoring stage.

It is understood that, as long as the model training is completed at the terminal device 110, the output of the positioning model is relatively accurate, therefore the model monitoring is not needed right away. The model monitoring is not performed during the time period after the training, and thus the overhead can be reduced.

The model monitoring can validate the trained positioning model since the channel environment changes in real time and the model needs to be adjusted accordingly. In some embodiments, the model monitoring can be implemented at the terminal device 110 by receiving positioning reference signals and by transmitting sounding reference signals with a sparser resource than that for model training. In this event, the reference signal overhead can be reduced.

In some embodiments, if the terminal device 110 determines that the output of the positioning model is far away from the result of multi-RTT measurements, the terminal device 110 can determines that the trained positioning model is not available any more. In some embodiments, the terminal device 110 may further update the positioning model, in the stage of model updating, to adapt the changes of the channel environment. The model updating can be performed based on a dataset obtained based on the second reference signal resource similar with the second dataset.

In some embodiments, the terminal device 110 may further inform the network device 120 to re-download another positioning model to determine the location of the terminal device 110. In some embodiments, the terminal device 110 may further determine the location of the terminal device 110 by a traditional positioning mechanism, without using the trained positioning model any more.

Therefore, the model monitoring can be performed by the terminal device 110 to evaluate the trained positioning model, to make sure that the positioning model being used has an accurate output. Additionally, a gap is configured between the training stage and the monitoring stage and a sparser reference signal resource is configured for the model monitoring, thus the overhead can be reduced and the communication efficiency can be improved.

According to the embodiments described with reference to FIG. 2 to FIG. 7, the AI/ML based positioning model can be deployed at the terminal device 110. In this way, the positioning model can be trained and monitored by the terminal device 110, and the position of the terminal device 110 can be estimated more accurately.

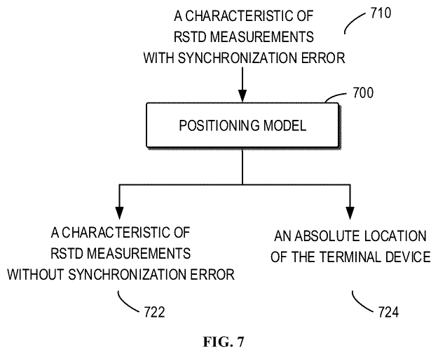

In some embodiments of the present disclosure, the AI/ML based positioning model can be deployed at the core network device 130, such as at LMF 132. Embodiments of the present disclosure where the AI/ML based positioning model is implemented at the LMF 132 will be described in detail below. To simplify the description, the AI/ML based positioning model is called as a positioning model for short. Reference is first made to FIG. 8, which illustrates a signaling chart illustrating process 800 according to some example embodiments of the present disclosure. Only for the purpose of discussion, the process 800 will be described with reference to FIG. 1. The process 800 may involve the terminal device 110, the network device 120 and the core network device 130 in FIG. 1, and the core terminal device 130 comprises LMF 132.

The positioning model is triggered 810. In some embodiments of the present disclosure, the triggering operation may be caused by the terminal device 110 or by the network device 120, and the triggering condition(s) may be determined by the terminal device 110 or by the network device 120, based on the specific implementation. The trigger at 810 in FIG. 8 is similar with that described in FIG. 2 and thus is not repeated here.

The network device 120 transmits 820 a configuration message to the terminal device 110. In some embodiments, the configuration message may comprise a request to determine datasets based on multi round trip time (multi-RTT) mechanism. In some embodiments, the configuration message may comprises a first configuration and a second configuration, where the first configuration indicates a first reference signal resource for the stage of model training, the second configuration indicates a second reference signal resource for the stage of model monitoring, and the second reference signal resource is sparser than the first reference signal resource. In some embodiments, the configuration message may comprise information indicating a time period between the model training stage and the model monitoring stage, where the time period may indicate a time gap between the training and the monitoring. In some embodiments, the configuration message may comprise a termination indication for model training. The transmission of the configuration message at 820 in FIG. 8 is similar with that described in FIG. 2 and thus is not repeated here.

Alternatively, the network device 110 may transmit 822 another configuration message to the core network device 130. In some embodiments, the another configuration message may comprise information indicating a time period between the model training stage and the model monitoring stage, where the time period may indicate a time gap between the training and the monitoring. In some embodiments, the another configuration message may comprise a termination indication for model training. The description of the time period and the termination indication at 822 in FIG. 8 is similar with that described in FIG. 2 and thus is not repeated here.

The terminal device 110 determines 830 a first dataset which will be used for training the positioning model. The determination of the first dataset at 830 in FIG. 8 is similar with that described in FIG. 2 and thus is not repeated here. Further the terminal device 110 transmits 832 the first dataset to the core network device 130, specifically to the LMF 132. In some embodiments, the terminal device 110 can transmit the first dataset through a LPP signaling.

The LMF 132 trains 840 the positioning model based on the first dataset. The training of the positioning model performed by the LMF 132 at 840 in FIG. 8 is similar with the training of the positioning model performed by the terminal device 110 at 240 described in FIG. 2 and thus is not repeated here.

The LMF 132 terminates 842 the training. In some embodiments, the training may be stopped based on a termination condition. In some embodiments, the terminal condition may be configured by the network device 120. In some examples, the termination indication is included in the another configuration message transmitted at 822. In some other examples, the termination indication may be transmitted from the terminal device 110, alternatively, the terminal device 110 may transmit 834 training parameters to the LMF 132, where the training parameters comprise the termination indication and where the termination indication is received by the terminal device 110 at 820. The termination indication may be a training duration or may be a number of reference signal resources discussed above. In this event, the LMF 132 can perform the training within the training duration, and the training is completed as long as the training duration lapses.

In some embodiments, the termination condition may be determined by the LMF 132. For example, if no termination indication is transmitted at 822 or 834, then the LMF 132 can judge whether the training is completed by itself. In some examples, if the termination condition is determined by the LMF 132, alternatively the LMF 132 may transmit 844 a transmission to the network device 120 to notify that the training has been completed.

Additionally, the LMF 132 determines 850 location related information of the terminal device 110 based on the trained positioning model. Specifically, the trained positioning model can be used during the stage of model inference.

The terminal device 110 determines 860 a second dataset which will be used for monitoring the trained positioning model. The determination of the second dataset at 860 in FIG. 8 is similar with that described in FIG. 2 and thus is not repeated here. Further the terminal device 110 transmits 862 the second dataset to the core network device 130, specifically to the LMF 132. In some embodiments, the terminal device 110 can transmit the second dataset through a LPP signaling.

The LMF 132 monitors 864 the trained positioning model based on the second dataset. Alternatively or in addition, the LMF 132 may determine 863 whether the time period lapses after the training is terminated. For example, a timer may exist at the LMF 132 and the timer can be started when the training is completed. If the LMF 132 determines that the time period lapses, then the LMF 132 can monitor the positioning model. In some embodiments, information about the time period can be transmitted at 822. In some embodiments, information about the time period can be transmitted at 834, in other words, the training parameters transmitted at 834 may comprise the information about the time period, where the information about the time period is received by the terminal device 110 at 820. In some embodiments, if the LMF 132 determines that the output of the positioning model is far away from the result of multi-RTT measurements by monitoring, the LMF 132 can determines that the trained positioning model is not available any more. In some embodiments, the LMF 132 may further update the positioning model, in the stage of model updating, to adapt the changes of the channel environment. In some embodiments, the LMF 132 may further re-download another positioning model from the network device 120 to determine the location of the terminal device 110. In some embodiments, the LMF 132 may further determine the location of the terminal device 110 by a traditional positioning mechanism, without using the trained positioning model any more.

According to the embodiments described with reference to FIG. 8, the AI/ML based positioning model can be deployed at the LMF 132. In this way, the positioning model can be trained and monitored by the LMF 132, the processing capacity of the LMF 132 can be fully utilized and the efficiency can be improved. Further, the training and the monitoring are not performed at the terminal device 110, there is no need for the terminal device 110 to download the positioning model for the network side and the calculation amount at the terminal device can be reduced which is conductive to power saving.

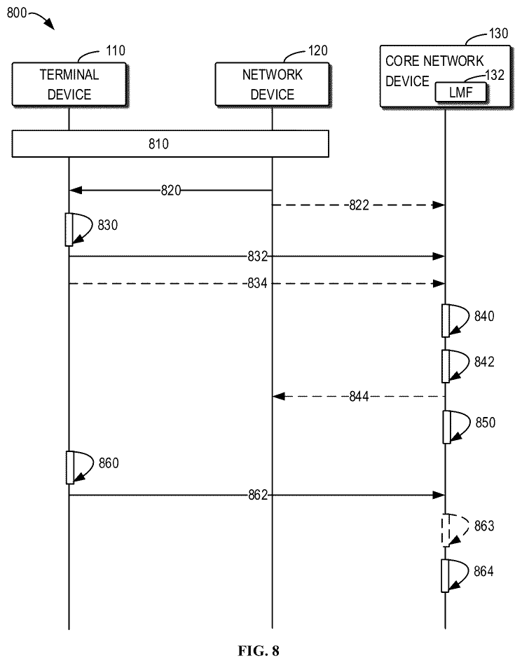

FIG. 9 illustrates a flowchart of an example method 900 in accordance with some embodiments of the present disclosure. The method 900 can be implemented at a communication device, and the communication device can be a terminal device 110 or a core network device 130 as shown in FIG. 1. It is to be understood that the method 900 may include additional blocks not shown and/or may omit some blocks as shown, and the scope of the present disclosure is not limited in this regard.

At block 910, if a positioning model is triggered, the communication device obtains a first dataset, where the first dataset is generated based at least on a plurality of reference signals with a first reference signal resource.

At block 920, the communication device trains the positioning model based on the first dataset.

At block 930, the communication device obtains a second dataset based at least on a plurality of reference signals with a second reference signal resource, where the second reference signal resource density is sparser than the first reference signal resource density.

At block 940, the communication device monitors the trained positioning model based on the second dataset.

In some embodiments, the periodicity of the first reference signal resource not exceeds a first threshold, and the periodicity of the second reference signal resource exceeds a second threshold.

In some embodiments, the communication device is the terminal device 110. The terminal device 110 may receives a first configuration of the first reference signal resource of the positioning model for a training stage and a second configuration of the second reference signal resource of the positioning model for a monitoring stage from the network device 120. The first configuration comprises a first periodicity of reference signals. The second configuration comprises at least one of: a number of reference signals within a group of reference signals, a second periodicity of reference signals for each group of reference signals, or a gap between a first group of reference signals and a second group of reference signals following the first group.

In some embodiments, the communication device is the terminal device 110. The terminal device 110 may receive a request to determine the first dataset and the second dataset based on multi-RTT mechanism from the network device 120.

In some embodiments, the communication device is the terminal device 110. The terminal device 110 may determine location related information of a terminal device based on the trained positioning model, where the location related information comprises at least one of: reference signal time difference (RSTD) without synchronization error, or an absolute location of the terminal device. Alternatively or in addition, the terminal device 110 may transmit the location related information of the terminal device to the LMF 132.

In some embodiments, the communication device is LMF 132. The LMF 132 may receive the first dataset from the terminal device 110, and the LMF 132 may receive the second dataset from the terminal device 110. The first dataset and the second dataset are generated by the terminal device 110.

In some embodiments, the communication device is LMF 132. The LMF 132 may determine location related information of a terminal device based on the trained positioning model, where the location related information comprises at least one of: reference signal time difference (RSTD) without synchronization error, or an absolute location of the terminal device.

In some embodiments, the communication device may terminate the training based on at least one of the following: a transmission to a network device notifying the termination of the training, a training duration configured by the network device 120, or a number of the plurality of reference signals configured by the network device 120.

In some embodiments, if a time period lapses after the training is terminated, the communication device may obtain the second dataset so as to performing the model monitoring, where the time period is configured by the network device 120.

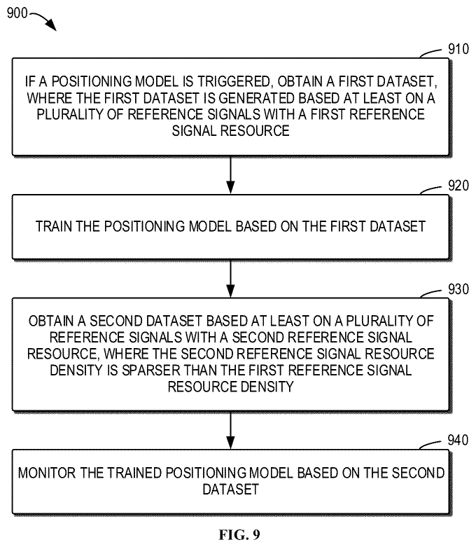

In some embodiments, the first dataset comprises at least: a characteristic of RSTD measurements with synchronization error; and a characteristic of RSTD measurements without synchronization error or an absolute location of the terminal device 110. FIG. 10 illustrates a flowchart of an example method 1000 in accordance with some embodiments of the present disclosure. The method 1000 can be implemented at a terminal device 110 as shown in FIG. 1. It is to be understood that the method 1000 may include additional blocks not shown and/or may omit some blocks as shown, and the scope of the present disclosure is not limited in this regard.

At block 1010, the terminal device 110 receives from the network device 120 a request to determine a data based on multi-RTT mechanism.

At block 1020, the terminal device 110 determines the dataset for a positioning model based on the request, where the dataset comprises at least: a characteristic of RSTD measurements with synchronization error; and a characteristic of RSTD measurements without synchronization error or an absolute location of the terminal device 110.

In some embodiments, the dataset may be a first dataset. The terminal device 110 may transmit the first dataset to the LMF 132 for training the positioning model. In some embodiments, the dataset may be a second dataset. The terminal device 110 may transmit the second dataset to the LMF 132 for monitoring the positioning model.

In some embodiments, the terminal device 110 may receive from the network device 120 a first configuration of a first reference signal resource of the positioning model for a training stage and a second configuration of a second reference signal resource of the positioning model for a monitoring stage, the first reference signal resource is denser than the second reference signal resource. The first configuration comprises a first periodicity of reference signals. The second configuration comprises at least one of: a number of reference signals within a group of reference signals, a second periodicity of reference signals for each group of reference signals, or a gap between a first group of reference signals and a second group of reference signals following the first group.

In some embodiments, the terminal device 110 may generate the first dataset based on the first configuration, and the terminal device 110 may train the positioning model based on the first dataset.

In some embodiments, the terminal device 110 may terminate the training based on at least one of the following: a transmission to a network device notifying the termination of the training, a training duration configured by the network device 120, or a number of the plurality of reference signals configured by the network device 120.

In some embodiments, the terminal device 110 may determine location related information of a terminal device based on the trained positioning model, where the location related information comprises at least one of: reference signal time difference (RSTD) without synchronization error, or an absolute location of the terminal device. Alternatively or in addition, the terminal device 110 may transmit the location related information of the terminal device to the LMF 132.

In some embodiments, the terminal device 110 may generate the second dataset based on the second configuration, and the terminal device 110 may monitor the trained positioning model based on the second dataset.

In some embodiments, if a time period lapses after the training is terminated, the terminal device 110 may obtain the second dataset so as to performing the model monitoring, where the time period is configured by the network device 120.

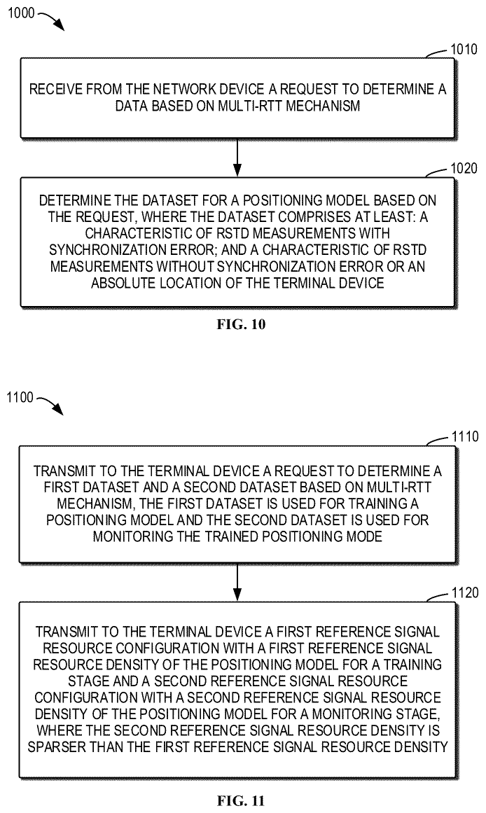

FIG. 11 illustrates a flowchart of an example method 1100 in accordance with some embodiments of the present disclosure. The method 1100 can be implemented at a network device 120 as shown in FIG. 1. It is to be understood that the method 1100 may include additional blocks not shown and/or may omit some blocks as shown, and the scope of the present disclosure is not limited in this regard.

At block 1110, the network device 120 transmits to the terminal device 110 a request to determine a first dataset and a second dataset based on multi-RTT mechanism, the first dataset is used for training a positioning model and the second dataset is used for monitoring the trained positioning mode.

At block 1120, the network device 120 transmits to the terminal device 110 a first reference signal resource configuration with a first reference signal resource density of the positioning model for a training stage and a second reference signal resource configuration with a second reference signal resource density of the positioning model for a monitoring stage, where the second reference signal resource density is sparser than the first reference signal resource density.

In some embodiments, the first reference signal resource configuration comprises a first periodicity of reference signals. In some embodiments, the second reference signal resource configuration comprises at least one of: a number of reference signals within a group of reference signals, a second periodicity of reference signals for each group of reference signals, or a gap between a first group of reference signals and a second group of reference signals following the first group.

In some embodiments, the network device 120 receives an uplink transmission from the terminal device 110 notifying the termination of the training.

In some embodiments, the network device 120 receives location related information of the terminal device 110 from the terminal device 110, where the location related information comprises at least one of: reference signal time difference (RSTD) without synchronization error, or an absolute location of the terminal device.

Details for channel access in millimeter wave bands according to the present disclosure have been described with reference to FIGS. 1-11. Now an example implementation of the device will be discussed below.

In some example embodiments, the terminal device comprises circuitry configured to: if a positioning model is triggered, obtain a first dataset, where the first dataset is generated based at least on a plurality of reference signals with a first reference signal resource; train the positioning model based on the first dataset; obtain a second dataset based at least on a plurality of reference signals with a second reference signal resource, where a density of the second reference signal resource is sparser than a density of the first reference signal resource; and monitor the trained positioning model based on the second dataset.

In some embodiments, the periodicity of the first reference signal resource not exceeds a first threshold, and the periodicity of the second reference signal resource exceeds a second threshold.

In some embodiments, the terminal device comprises circuitry configured to: receive a first configuration of the first reference signal resource of the positioning model for a training stage and a second configuration of the second reference signal resource of the positioning model for a monitoring stage from the network device. The first configuration comprises a first periodicity of reference signals. The second configuration comprises at least one of: a number of reference signals within a group of reference signals, a second periodicity of reference signals for each group of reference signals, or a gap between a first group of reference signals and a second group of reference signals following the first group.

In some embodiments, the terminal device comprises circuitry configured to: receive a request to determine the first dataset and the second dataset based on multi-RTT mechanism from the network device.

In some embodiments, the terminal device comprises circuitry configured to: determine location related information of a terminal device based on the trained positioning model, where the location related information comprises at least one of: reference signal time difference (RSTD) without synchronization error, or an absolute location of the terminal device.

In some embodiments, the terminal device comprises circuitry configured to: transmit the location related information of the terminal device to the LMF.

In some embodiments, the terminal device comprises circuitry configured to: terminate the training based on at least one of the following: a transmission to a network device notifying the termination of the training, a training duration configured by the network device, or a number of the plurality of reference signals configured by the network device.

In some embodiments, the terminal device comprises circuitry configured to: if a time period lapses after the training is terminated, obtain the second dataset so as to performing the model monitoring, where the time period is configured by the network device.

In some embodiments, the first dataset comprises at least: a characteristic of RSTD measurements with synchronization error; and a characteristic of RSTD measurements without synchronization error or an absolute location of the terminal device.

In some example embodiments, the LMF comprises circuitry configured to: if a positioning model is triggered, obtain a first dataset, where the first dataset is generated based at least on a plurality of reference signals with a first reference signal resource; train the positioning model based on the first dataset; obtain a second dataset based at least on a plurality of reference signals with a second reference signal resource, where a density of the second reference signal resource is sparser than a density of the first reference signal resource; and monitor the trained positioning model based on the second dataset.

In some embodiments, the LMF comprises circuitry configured to: receive the first dataset from the terminal device, and receive the second dataset from the terminal device. The first dataset and the second dataset are generated by the terminal device.

In some embodiments, the LMF comprises circuitry configured to: determine location related information of a terminal device based on the trained positioning model, where the location related information comprises at least one of: reference signal time difference (RSTD) without synchronization error, or an absolute location of the terminal device.

In some embodiments, the LMF comprises circuitry configured to: terminate the training based on at least one of the following: a transmission to a network device notifying the termination of the training, a training duration configured by the network device, or a number of the plurality of reference signals configured by the network device.

In some embodiments, the LMF comprises circuitry configured to: if a time period lapses after the training is terminated, obtain the second dataset so as to performing the model monitoring, where the time period is configured by the network device.

In some embodiments, the first dataset comprises at least: a characteristic of RSTD measurements with synchronization error; and a characteristic of RSTD measurements without synchronization error or an absolute location of the terminal device.

In some example embodiments, the terminal device comprises circuitry configured to: receive from the network device a request to determine a data based on multi-RTT mechanism; and determine the dataset for a positioning model based on the request, where the dataset comprises at least: a characteristic of RSTD measurements with synchronization error; and a characteristic of RSTD measurements without synchronization error or an absolute location of the terminal device.

In some embodiments, the dataset may be a first dataset, and the terminal device comprises circuitry configured to transmit the first dataset to the LMF for training the positioning model.

In some embodiments, the dataset may be a second dataset, and the terminal device comprises circuitry configured to transmit the second dataset to the LMF for monitoring the positioning model.

In some embodiments, the terminal device comprises circuitry configured to receive from the network device a first configuration of a first reference signal resource of the positioning model for a training stage and a second configuration of a second reference signal resource of the positioning model for a monitoring stage, the first reference signal resource is denser than the second reference signal resource. The first configuration comprises a first periodicity of reference signals. The second configuration comprises at least one of: a number of reference signals within a group of reference signals, a second periodicity of reference signals for each group of reference signals, or a gap between a first group of reference signals and a second group of reference signals following the first group.

In some embodiments, the terminal device comprises circuitry configured to generate the first dataset based on the first configuration, and train the positioning model based on the first dataset.

In some embodiments, the terminal device comprises circuitry configured to terminate the training based on at least one of the following: a transmission to a network device notifying the termination of the training, a training duration configured by the network device, or a number of the plurality of reference signals configured by the network device.

In some embodiments, the terminal device comprises circuitry configured to determine location related information of a terminal device based on the trained positioning model, where the location related information comprises at least one of: reference signal time difference (RSTD) without synchronization error, or an absolute location of the terminal device.

In some embodiments, the terminal device comprises circuitry configured to transmit the location related information of the terminal device to the LMF.

In some embodiments, the terminal device comprises circuitry configured to generate the second dataset based on the second configuration, and monitor the trained positioning model based on the second dataset.

In some embodiments, the terminal device comprises circuitry configured to: if a time period lapses after the training is terminated, obtain the second dataset so as to performing the model monitoring, where the time period is configured by the network device.

In some example embodiments, the network device comprises circuitry configured to: transmit to the terminal device a request to determine a first dataset and a second dataset based on multi-RTT mechanism, the first dataset is used for training a positioning model and the second dataset is used for monitoring the trained positioning mode; and transmit to the terminal device a first reference signal resource configuration with a first reference signal resource density of the positioning model for a training stage and a second reference signal resource configuration with a second reference signal resource density of the positioning model for a monitoring stage, where the second reference signal resource density is sparser than the first reference signal resource density.

In some embodiments, the first reference signal resource configuration comprises a first periodicity of reference signals. In some embodiments, the second reference signal resource configuration comprises at least one of: a number of reference signals within a group of reference signals, a second periodicity of reference signals for each group of reference signals, or a gap between a first group of reference signals and a second group of reference signals following the first group.

In some embodiments, the network device comprises circuitry configured to receive an uplink transmission from the terminal device notifying the termination of the training.

In some embodiments, the network device comprises circuitry configured to receive location related information of the terminal device from the terminal device, where the location related information comprises at least one of: reference signal time difference (RSTD) without synchronization error, or an absolute location of the terminal device.

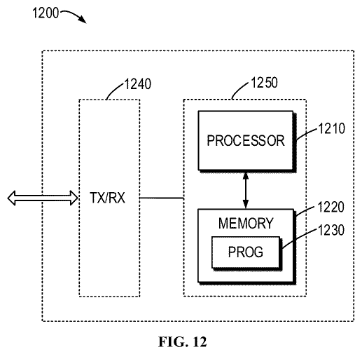

FIG. 12 illustrates a simplified block diagram of a device 1200 that is suitable for implementing embodiments of the present disclosure. The device 1200 can be considered as a further example implementation of the terminal device 110, the network device 120 and/or the core network device 130 as shown in FIG. 1. Accordingly, the device 1200 can be implemented at or as at least a part of the terminal device 110, or the network device 120.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1210 stores at least a part of a program 1230. The TX/RX 1240 is for bidirectional communications. The TX/RX 1240 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1230 is assumed to include program instructions that, when executed by the associated processor 1210, enable the device 1200 to operate in accordance with the embodiments of the present disclosure, as discussed herein with reference to FIGS. 2-10. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

In summary, embodiments of the present disclosure may provide the following solutions.

The present disclosure provides a method of communication, comprising: in accordance with a determination that a positioning model is triggered, obtaining a first dataset, the first dataset being generated based at least on a plurality of reference signals with a first reference signal resource; training the positioning model based on the first dataset; obtaining a second dataset based at least on a plurality of reference signals with a second reference signal resource, the second reference signal resource density being sparser than the first reference signal resource density; and monitoring the trained positioning model based on the second dataset.

In some embodiments, the method further comprises: terminating the training based on at least one of the following: a transmission to a network device notifying the termination of the training, a training duration configured by a network device, or a number of the plurality of reference signals configured by the network device.

In some embodiments, the method further comprises: determining location related information of a terminal device based on the trained positioning model, wherein the location related information comprises at least one of: reference signal time difference (RSTD) without synchronization error, or an absolute location of the terminal device.

In some embodiments, the method is implemented at a terminal device, and the method further comprises: transmitting the location related information of the terminal device to a location and mobility function (LMF).

In some embodiments, the method is implemented at a terminal device, and the method further comprises: receiving, from a network device, a first configuration of the first reference signal resource of the positioning model for a training stage and a second configuration of the second reference signal resource of the positioning model for a monitoring stage, wherein the first configuration comprises a first periodicity of reference signals, and wherein the second configuration comprises at least one of: a number of reference signals within a group of reference signals, a second periodicity of reference signals for each group of reference signals, the each group comprising the number of reference signals, or a gap between a first group of reference signals and a second group of reference signals following the first group.

In some embodiments, the method is implemented at a terminal device, and the method further comprises: receiving, from the network device, a request to determine the first dataset and the second dataset based on multi round trip time (multi-RTT) mechanism.

In some embodiments, the method is implemented at a location and mobility function (LMF), and the obtaining a first dataset comprises receiving the first dataset from a terminal device, wherein the first dataset is generated by the terminal device; and the obtaining a second dataset comprises receiving the second dataset from the terminal device.

In some embodiments, the obtaining the second dataset comprises: in accordance with a determination that a time period lapses after the training is terminated, obtaining the second dataset, wherein the time period is configured by a network device.

In some embodiments, the periodicity of the first reference signal resource not exceeds a first threshold, and the periodicity of the second reference signal resource exceeds a second threshold.

In some embodiments, the first dataset comprises: a characteristic of RSTD measurements with synchronization error, and a characteristic of RSTD measurements without synchronization error or an absolute location of a terminal device.

The present disclosure provides a method of communication implemented at a terminal device, comprising: receiving, from a network device, a request to determine a dataset based on multi round trip time (multi-RTT) mechanism; and determining the dataset for a positioning model based on the request, the dataset comprising at least: a characteristic of reference signal time difference (RSTD) with synchronization error, and a characteristic of RSTD without synchronization error or an absolute location of the terminal device.

In some embodiments, the method further comprises: transmitting, to a location and mobility function (LMF), the dataset for training or monitoring the positioning model.

In some embodiments, the method further comprises: receiving, from a network device, a first configuration of the first reference signal resource of the positioning model for a training stage and a second configuration of the second reference signal resource of the positioning model for a monitoring stage, where the first configuration comprises a first periodicity of reference signals, and where the second configuration comprises at least one of: a number of reference signals within a group of reference signals, a second periodicity of reference signals for each group of reference signals, or a gap between a first group of reference signals and a second group of reference signals following the first group.

In some embodiments, the method further comprises: training the positioning model based on the first dataset; and monitoring the trained positioning model based on the second dataset.

In some embodiments, the method further comprises: terminating the training based on at least one of the following: a transmission to a network device notifying the termination of the training, a training duration configured by a network device, or a number of the plurality of reference signals configured by the network device.

In some embodiments, the method further comprises: determining location related information of a terminal device based on the trained positioning model, wherein the location related information comprises at least one of: reference signal time difference (RSTD) without synchronization error, or an absolute location of the terminal device.

In some embodiments, the method further comprises: transmitting the location related information of the terminal device to a location and mobility function (LMF).

In some embodiments, the monitoring comprises: in accordance with a determination that a time period lapses after the training is terminated, monitoring the trained positioning model, wherein the time period is configured by a network device.

In some embodiments, the periodicity of the first reference signal resource not exceeds a first threshold, and the periodicity of the second reference signal resource exceeds a second threshold.

In some embodiments, the first dataset comprises: a characteristic of RSTD measurements with synchronization error, and a characteristic of RSTD measurements without synchronization error or an absolute location of a terminal device.

The present disclosure provides a method of communication implemented at a network device, comprising: transmitting, to a terminal device, a request to determine a first dataset and a second dataset based on multi round trip time (multi-RTT) mechanism, the first dataset being used for training a positioning model and the second dataset being used for monitoring the trained positioning mode; and transmitting, to the terminal device, a first reference signal resource configuration with a first reference signal resource density of the positioning model for a training stage and a second reference signal resource configuration with a second reference signal resource density of the positioning model for a monitoring stage, wherein the second reference signal resource density being sparser than the first reference signal resource density.

In some embodiments, the first reference signal resource configuration comprises a first periodicity of reference signals, and the second reference signal resource configuration comprises at least one of: a number of reference signals within a group of reference signals, a second periodicity of reference signals for each group of reference signals, or a gap between a first group of reference signals and a second group of reference signals following the first group.

In some embodiments, the method further comprises: receiving, from the terminal device, location related information of the terminal device, wherein the location related information comprises at least one of: reference signal time difference (RSTD) without synchronization error, or an absolute location of the terminal device.

In some embodiments, the method further comprises: receiving an uplink transmission from the terminal device notifying the termination of the training.

The present disclosure provides a communication device, comprising: a processor configured to cause the communication device to perform the method implemented at a communication device discussed above.

The present disclosure provides a terminal device, comprising: a processor configured to cause the terminal device to perform the method implemented at a terminal device discussed above.

The present disclosure provides a network device, comprising: A processor configured to cause the network device to perform the method implemented at a network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 11-22. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
in accordance with a determination that a positioning model is triggered, obtaining a first dataset, the first dataset being generated based at least on a plurality of reference signals with a first reference signal resource;
training the positioning model based on the first dataset;
obtaining a second dataset based at least on a plurality of reference signals with a second reference signal resource, the second reference signal resource density being sparser than the first reference signal resource density; and
monitoring the trained positioning model based on the second dataset.

2. The method of claim 1, further comprising:
determining that the training is terminated based on at least one of the following:
a transmission to a network device notifying the termination of the training,
a training duration configured by a network device, or
a number of the plurality of reference signals configured by the network device.

3. The method of claim 1, further comprising:
determining location related information of a terminal device based on the trained positioning model, wherein the location related information comprises at least one of:
reference signal time difference (RSTD) without synchronization error, or
an absolute location of the terminal device.

4. The method of claim 3, wherein the method is implemented at a terminal device, and wherein the method further comprises:
transmitting the location related information of the terminal device to a location and mobility function (LMF).

5. The method of claim 1, wherein the method is implemented at a terminal device, and wherein the method further comprises:
receiving, from a network device, a first configuration of the first reference signal resource of the positioning model for a training stage and a second configuration of the second reference signal resource of the positioning model for a monitoring stage,
wherein the first configuration comprises a first periodicity of reference signals, and
wherein the second configuration comprises at least one of:
a number of reference signals within a group of reference signals,
a second periodicity of reference signals for each group of reference signals, the each group comprising the number of reference signals, or
a gap between a first group of reference signals and a second group of reference signals following the first group.

6. The method of claim 1, wherein the method is implemented at a terminal device, and wherein the method further comprises:
receiving, from the network device, a request to determine the first dataset and the second dataset based on multi round trip time (multi-RTT) mechanism.

7. The method of claim 1, wherein the method is implemented at a location and mobility function (LMF), and wherein,
obtaining a first dataset comprises receiving the first dataset from a terminal device, wherein the first dataset is generated by the terminal device; and
obtaining a second dataset comprises receiving the second dataset from the terminal device.

8. The method of claim 1, wherein obtaining the second dataset comprises:
in accordance with a determination that a time period lapses after the training is terminated, obtaining the second dataset, wherein the time period is configured by a network device.

9. The method of claim 1, wherein the periodicity of the first reference signal resource not exceeds a first threshold, and the periodicity of the second reference signal resource exceeds a second threshold.

10. The method of claim 1, wherein the first dataset comprises:
a characteristic of RSTD measurements with synchronization error, and
a characteristic of RSTD measurements without synchronization error or an absolute location of a terminal device.

11. A method of communication implemented at a terminal device, comprising:
receiving, from a network device, a request to determine a dataset based on multi round trip time (multi-RTT) mechanism; and
determining the dataset for a positioning model based on the request, the dataset comprising at least:
a characteristic of reference signal time difference (RSTD) with synchronization error, and
a characteristic of RSTD without synchronization error or an absolute location of the terminal device.

12. The method of claim 11, further comprising:
transmitting, to a location and mobility function (LMF), the dataset for training or monitoring the positioning model.

13. A method of communication implemented at a network device, comprising:
transmitting, to a terminal device, a request to determine a first dataset and a second dataset based on multi round trip time (multi-RTT) mechanism, the first dataset being used for training a positioning model and the second dataset being used for monitoring the trained positioning mode; and
transmitting, to the terminal device, a first reference signal resource configuration with a first reference signal resource density of the positioning model for a training stage and a second reference signal resource configuration with a second reference signal resource density of the positioning model for a monitoring stage, wherein the second reference signal resource density being sparser than the first reference signal resource density.

14. The method of claim 13,
wherein the first reference signal resource configuration comprises a first periodicity of reference signals, and
wherein the second reference signal resource configuration comprises at least one of:
a number of reference signals within a group of reference signals,
a second periodicity of reference signals for each group of reference signals, or
a gap between a first group of reference signals and a second group of reference signals following the first group.

15. The method of claim 13, further comprising:
receiving, from the terminal device, a transmission notifying a termination of the training.

16. The method of claim 13, further comprising:
receiving, from the terminal device, location related information of the terminal device, wherein the location related information comprises at least one of:
reference signal time difference (RSTD) without synchronization error, or
an absolute location of the terminal device.

17.-20. (canceled)
